(19) United States
(12) Patent Application Publication
(10) Pub. No.: US 2010/0190536 A1
(43) Pub. Date: Jul. 29, 2010

(54) Headset holster

(76) Inventor: Barbara Blasko, Anaheim, CA (US)

Correspondence Address: LAW OFFICES OF CLEMENT CHENG, 17220 NEWHOPE STREET #127, FOUNTAIN VALLEY, CA, 92708, US

(21) Appl. No.: 12/321,942

(22) Filed: Jan. 27, 2009

(51) Int. Cl. H04M 1/00

(52) U.S. Cl. 455/575.2

(57) ABSTRACT

A headset holster receives a small headset and includes a base member having a top face and a bottom face. A pair of protrusions extend from the top face. A channel is formed between the pair of protrusions. An elastic strap extending between the pair of protrusions, over the channel. An adhesive tape is double-sided and adheres to the bottom face on a top surface of the adhesive tape. The adhesive tape has an adhesive bottom surface. A bottom rim may continue as a loop, or may be discontinuous on an inside area facing toward the elastic band. The headset holster is preferably attached to a cell phone, or wireless device.

### DISCUSSION OF RELATED ART

Cell phone headsets are crucial for hands-free operation a cell phone. Cell phone headsets are typically operated wirelessly on Bluetooth protocol, or other wireless protocol. Unfortunately, use of a headset is often short-lived due to user loss of the headset, or headset damage. Because the headsets are small, lightweight and fragile, the lifespan of a headset often diminishes rapidly once it is lost or misplaced.

A variety of cellphone headset holders have been devised to keep the headset from being lost. Many of these headset holders secure the headset to the cell phone. For example in Malhotra United States design Pat. D549,449 a magnetic clasp secures a strap for strapping a headset to a cell phone holster. The clasp construction for headset holding is widely used. For example, the belt mounted holder for the headset as described in Beauchan United States design Pat. D297,683 provides a belt connection secured by one snap button, and a headset connection secured by the combination of a second snap button and hook and loop tape.

Another alternative for headsets having wires is to use a case such as the headset storage system shown in Bosch United States patent publication US 2004/0204209 published Oct. 14, 2004, the disclosure of which is incorporated herein by reference.

### SUMMARY OF THE INVENTION

The headset holster generally has a base which is a rectangular plastic molded member having a particular shape. The plastic can be ABS or polyethylene. The headset holster base has a top face, a side face, and a pair of protrusions extending from the headset holster base. The side face comprises a perimeter around the top face. The top face opposes a bottom side. The top face is preferably a flat surface from one side of the elastic band to the other. When the top face is bounded by the pair of protrusions, the pair of protrusions define an hourglass shape on the top face, such that the top face has an hourglass shaped flat continuous surface. Although some surface variations during manufacturing may make the flat continuous surface not as flat as a perfectly flat surface, presently known manufacturing techniques for plastic molded injection are sufficient to manufacture the top face of the headset holster base.

The pair of protrusions oppose each other, and have mirror image symmetry such that the left and right pair of protrusions have a protrusion channel disposed on a top surface of the pair of protrusions and disposed on an outside side surface of the pair of protrusions. The protrusion channel extends from a top surface to an outside side surface of the pair of protrusions. A bottom channel extends from the protrusion channel, and extends across the entire bottom side of the base. The protrusion channel has the same width as the bottom channel. The bottom channel forms an opening between opposing bottom rim members.

The elastic band can be formed as multiple independent rubber strands having a fabric wrapping around them. The fabric wrapping preferably interweaves and interconnects to interconnect the multiple independent rubber strands. The independent rubber strands may comprise approximately eight strands which are secured together by a fabric wrapping. The fabric wrapping preferably has winding perpendicular to the longitudinal axis of the elastic band. The elastic band may have fabric wrapping cover of a variety of different colors. The elastic band is preferably made of a short section of elastic, which is overlapped and stitched together at an interface to form a loop. The interface where the stitching connects the opposite ends of the short section of elastic is preferably located the bottom side of the holster base.

On the bottom side of the holster base is a bottom rim which encircles partially or entirely a pad of adhesive tape. The adhesive tape is a more specific form of an adhesive pad, or adhesive member. The adhesive tape is formed as a pad having a thickness protruding downward past the bottom surface of the bottom rim. The adhesive pad preferably is formed of a polyolefin foam having a top surface and a bottom surface that are both disposed with contact adhesive. The surface of the polyolefin foam is finished to have a smooth surface for contact. The adhesive tape, formed as a pad is preferably secured in pairs. The elastic band preferably passes between the pair of adhesive tape. The bottom rim preferably has a constant thickness around the edge of the adhesive tape. The bottom rim may continue as a loop, or maybe discontinuous on an inside area facing toward the elastic band. The discontinuous portion is preferably flush with the bottom side of the holster base. When the discontinuous portion is flush with the bottom side of the holster, the bottom side of the holster has an hourglass shape, and a gap exists between the adhesive tape and the elastic band at the discontinuous portion.

### BRIEF DESCRIPTION OF THE DRAWINGS

FIG. 1 is a perspective view of the present invention.

FIG. 2 is a top view.

FIG. 3 is a bottom view of which the back is a mirror image.

FIG. 4 is a right side view, the left side view being a mirror image of the right side view.

FIG. 5 is a top view, the bottom view being a mirror image of the top view.

FIG. 6 is a view of the invention in use.

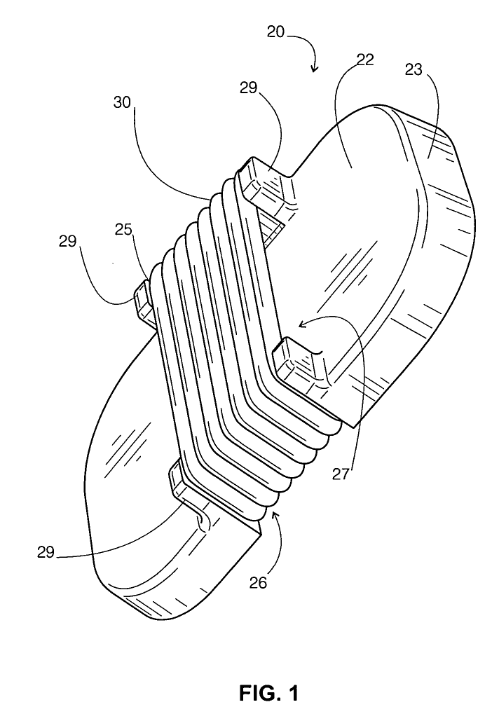

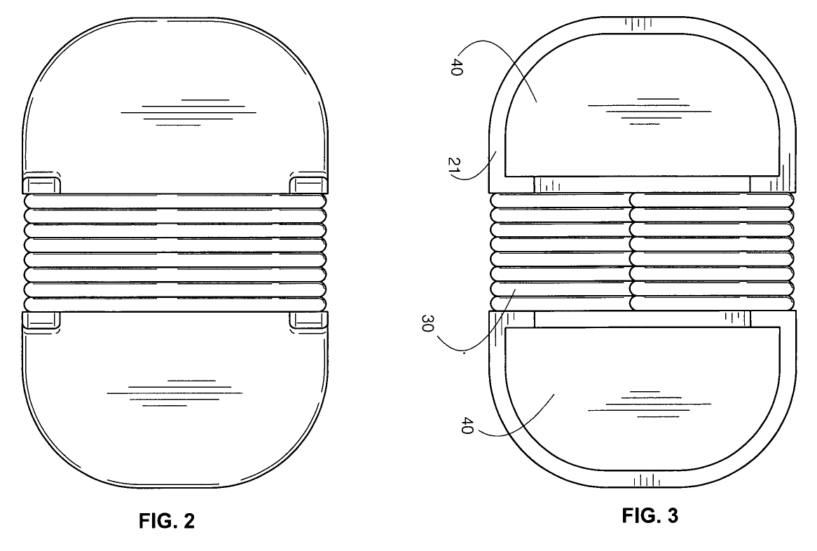

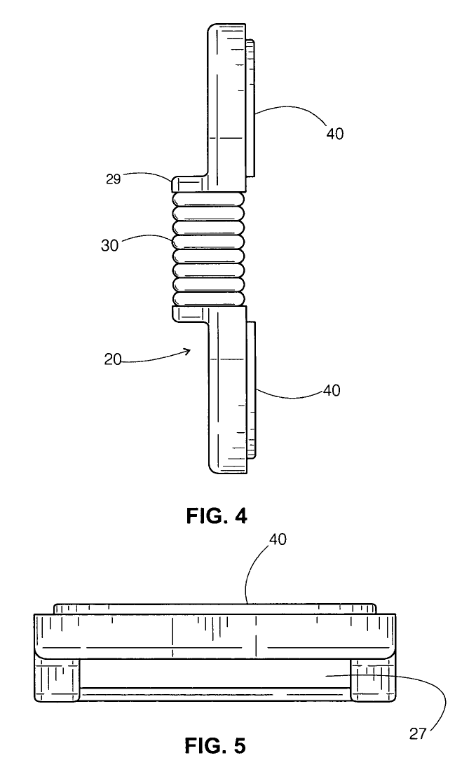

The following call out elements are used consistently throughout the drawings.

20 Base

21 Bottom Rim

22 Base Top Face

23 Base Side Face

25 Protrusion Channel

27 Main Channel

29 Protrusion

26 Bottom Channel

30 Elastic Band

40 Adhesive Tape

50 Headset

51 Headset Earbud

52 Headset Microphone Boom

60 Wireless Communications Device

### DETAILED DESCRIPTION OF THE PREFERRED EMBODIMENT

The headset holster generally has a base 20 which is a rectangular plastic molded member having a particular shape. The plastic can be ABS or polyethylene. The headset holster base 20 has a top face 22, a side face 23, and a pair of protrusions 29 extending from the headset holster base 20. The side face 23 comprises a perimeter around the top face 22 and the side face is preferably perpendicular to the top face. The top face opposes a bottom side. The top face is preferably a flat surface from one side of the elastic band 30 to the other. When the top face is bounded by the pair of protrusions 29, the pair of protrusions 29 define an hourglass shape on the top face, such that the top face has an hourglass shaped flat continuous surface. Although some surface variations during manufacturing may make the flat continuous surface not as flat as a perfectly flat surface, presently known manufacturing techniques for plastic molded injection are sufficient to manufacture the top face of the headset holster base 20.

The pair of protrusions 29 oppose each other, and have mirror image symmetry such that the left and right pair of protrusions have a protrusion channel disposed on a top surface of the pair of protrusions and disposed on an outside side surface of the pair of protrusions. The protrusion channel 25 extends from a top surface to an outside side surface of the pair of protrusions. A bottom channel 26 extends from the protrusion channel 25, and extends across the entire bottom side of the base 20. The protrusion channel 25 has the same width as the bottom channel 26. The bottom channel 26 forms an opening between opposing bottom rim 21 members.

The elastic band 30 can be formed as multiple independent rubber strands having a fabric wrapping around them. The fabric wrapping preferably interweaves and interconnects to interconnect the multiple independent rubber strands. The independent rubber strands may comprise approximately eight strands which are secured together by a fabric wrapping. The fabric wrapping preferably has winding perpendicular to the longitudinal axis of the elastic band 30. The elastic band 30 may have fabric wrapping cover of a variety of different colors. The elastic band 30 is preferably made of a short section of elastic, which is overlapped and stitched together at an interface to form a loop. The interface where the stitching connects the opposite ends of the short section of elastic is preferably located the bottom side of the holster base 20.

On the bottom side of the holster base 20 is a bottom rim 21 which encircles partially or entirely a pad of adhesive tape 40. The adhesive tape 40 is a more specific form of an adhesive pad, or adhesive member. The adhesive tape is formed as a pad having a thickness protruding downward past the bottom surface of the bottom rim 21. The adhesive pad preferably is formed of a polyolefin foam having a top surface and a bottom surface that are both disposed with contact adhesive. The surface of the polyolefin foam is finished to have a smooth surface for contact. The adhesive tape 40, formed as a pad is preferably secured in pairs. The elastic band 30 preferably passes between the pair of adhesive tape 40. FIG. 3 shows the adhesive tape in a half moon or D shaped configuration. The bottom rim 21 preferably has a constant thickness around the edge of the adhesive tape. The bottom rim may continue as a loop, or may be discontinuous on an inside area facing toward the elastic band 30. The discontinuous portion is preferably flush with the bottom side of the holster base 20. When the discontinuous portion is flush with the bottom side of the holster 20, the bottom side of the holster 20 has an hourglass shape, and a gap exists between the adhesive tape 40 and the elastic band 30 at the discontinuous portion.

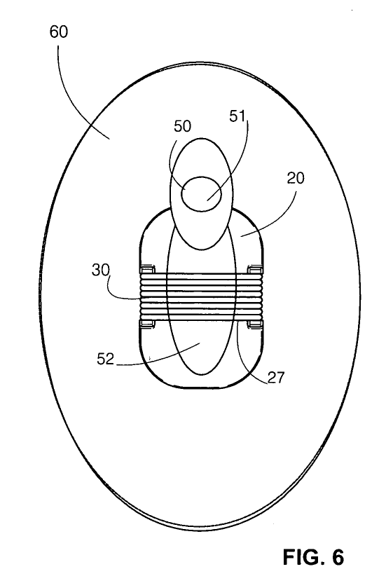

The headset holster is used to hold a wireless or wired headset. The headset holster is seen in use in FIG. 6 showing a headset 50 having an earbud 51 protruding away from the headset holster. The microphone boom 52 slips inside the main channel 27. The adhesive tape 40 is activated upon peeling away of the adhesive tape 40 cover members. Upon activation, the adhesive tape 40 adheres the headset holster to a wireless device 60 such as a cell phone. The headset holster is therefore attached to the cell phone, or a cell phone holster and the cell phone or cell phone holster is typically attached to a user. When a user needs to use the headset, the user slides out and removes the headset from the holster and places the earbud 51 into an ear. The elastic band, can be opaque, transparent or translucent and is preferably formed of multiple elastomeric cords, and is elastic and stretches to snug accommodation of the headset microphone boom 52.

The elastic band 30 can be of a high contrast color against the base of the headset holster. The elastic band 30 can be black and the base of the headset holster can be white.

Although the invention has been disclosed in detail with reference only to the preferred embodiments, those skilled in the art will appreciate that various other embodiments can be provided without departing from the scope of the invention. Accordingly, the invention is defined only by the claims set forth below.

1. A headset holster comprising:
a. a base member having a top face and a bottom face;
b. a pair of protrusions extending from the top face;
c. a channel formed between the pair of protrusions;
d. an elastic strap extending between the pair of protrusions, over the channel;
e. an adhesive tape being double-sided and adhering to the bottom face, on a top surface of the adhesive tape, and having an adhesive bottom surface.

2. The headset holster of claim 1, further comprising: a bottom rim continuing as a loop.

3. The headset holster of claim 2, wherein the bottom rim is discontinuous on an inside area facing toward the elastic band.

4. The headset holster of claim 3, wherein the bottom rim is flush with the bottom side of the holster base.

5. The headset holster of claim 2, wherein a bottom side of the holster 20 has an hourglass shape.

6. The headset holster of claim 1, wherein a gap exists between the adhesive tape and the elastic band at a discontinuous portion.

7. The headset holster of claim 1, wherein the elastic strap is formed as an elastic band, wherein the elastic band is formed as multiple independent elastic strands.

8. The headset holster of claim 7, wherein the multiple independent elastic strands have a fabric wrapping around them.

9. The headset holster of claim 8, wherein the fabric wrapping interweaves and interconnects to interconnect the multiple independent elastic strands.

10. The headset holster of claim 8, wherein there are at least four independent elastic strands, which are secured together by a fabric wrapping, wherein the fabric wrapping has winding perpendicular to a longitudinal axis of the elastic band.

11. The headset holster of claim 1, wherein the pair of protrusions oppose each other of sides of the base member.

12. The headset holster of claim 11, wherein the pair of protrusions each have a protrusion channel disposed on a top surface.

13. The headset holster of claim 12, wherein each a protrusion channel disposed on the top surface continues down an outside side surface of the pair of protrusions such that the protrusion channel extends from a top surface to an outside side surface of the pair of protrusions.

14. The headset holster of claim 12, wherein a bottom channel extends from the protrusion channel, and extends across the entire bottom side of the base.

15. The headset holster of claim 14, wherein a the protrusion channel has the same width as the bottom channel, wherein the bottom channel forms an opening between opposing bottom rim members.

16. The headset holster of claim 14, further comprising: a bottom rim continuing as a loop.

17. The headset holster of claim 16, wherein the bottom rim is discontinuous on an inside area facing toward the elastic band.

18. The headset holster of claim 17, wherein the bottom rim is flush with the bottom side of the holster base.

19. The headset holster of claim 14, wherein a gap exists between the adhesive tape and the elastic band at a discontinuous portion.

20. The headset holster of claim 14, wherein the elastic strap is formed as an elastic band, wherein the elastic band is formed as multiple independent elastic strands.
